(19) United States
(12) Patent Application Publication
(10) Pub. No.: US 2025/0167854 A1
(43) Pub. Date: May 22, 2025

(54) USER EQUIPMENT ADAPTIVELY DETERMINED L1-REFERENCE SIGNAL RECEIVED POWER QUANTIZATION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Hamed PEZESHKI, San Diego, CA (US)

(21) Appl. No.: 18/842,010

(22) PCT Filed: Apr. 29, 2022
(86) PCT No.: PCT/CN2022/090573

§ 371 Date: Aug. 27, 2024

(51) Int. Cl. H04B 7/06; H04B 17/309; H04L 1/00; H04W 24/10

(52) U.S. Cl. CPC H04B 7/0626; H04B 17/309; H04L 1/003; H04W 24/10

(57) ABSTRACT

Aspects relate to adaptively determining L1-reference signal received power (L1-RSRP) quantization in connection with channel state information (CSI) report. A user equipment receives a CSI configuration type and an identification of a CSI report quantity associated with a first number of channel measurement resources (CMRs). The user equipment reports a quantization scheme to quantize the CSI report quantity based on a total number of payload bits available to report the CSI report quantity. Aspects described herein may be applied to predictive beam management in some examples.

### TECHNICAL FIELD

The technology discussed below relates generally to channel state information reports, and more particularly, to user equipment adaptively determined L1-reference signal received power (L1-RSRP) quantization in connection with channel state information reports, which may be utilized in predictive beam management.

### INTRODUCTION

In beam management, a user equipment may generally report a strongest L1-RSRP in connection with, for example, initial access and a beam sweeping procedure. For certain machine learning-assisted predictive beam management use cases, the practice of reporting the strongest L1-RSRPs may lead to sub-optimal results. Given measured L1-RSRPs associated with different beams at a certain time instance, the user equipment may have better insight into which of the measured L1-RSRPs to report and/or may have better insight into how to quantize the reported L1-RSRPs.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a wireless communication device is disclosed. The wireless communication device includes a wireless transceiver, a memory, and a processor communicatively coupled to the wireless transceiver and the memory. In the example, the processor and the memory are configured to: receive a channel state information (CSI) configuration type and an identification of a CSI report quantity associated with a first number of channel measurement resources (CMRs) and report a quantization scheme to quantize the CSI report quantity based on a total number of payload bits available to report the CSI report quantity.

In another example, a method at a wireless communication device is disclosed. The method includes receiving a CSI configuration type and an identification of a CSI report quantity associated with a first number of channel measurement resources (CMRs) and reporting a quantization scheme to quantize the CSI report quantity based on a total number of payload bits available to report the CSI report quantity.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is an expanded view of an exemplary subframe, showing an orthogonal frequency divisional multiplexing (OFDM) resource grid according to some aspects of the disclosure.

FIG. 4 is a schematic diagram illustrating some aspects of beam management according to some aspects of the disclosure.

FIGS. 5A, 5B, and 5C are graphical depictions of a hierarchical beam refinement procedure according to some aspects of the disclosure.

FIG. 6 is a block diagram depicting a use of artificial intelligence and/or machine learning in a collection of data according to some aspects of the disclosure.

FIG. 7 is a schematic diagram representing a periodic state and periodic measurements of a plurality of beams at one network access node over time according to some aspects of the disclosure.

FIGS. 8A and 8B are schematic diagrams representing explicit and implicit spatial diversity beam prediction, respectively, according to some aspects of the disclosure.

FIG. 9 is a schematic representation of network access node configured or indicated periodic/semipersistent/aperiodic channel state information reports according to some aspects of the disclosure.

FIGS. 10A and 10B are schematic representations of two options of quantization scheme reporting according to some aspects of the disclosure.

FIG. 11 is a block diagram illustrating an example of a hardware implementation of a wireless communication device employing a processing system according to some aspects of the disclosure.

FIG. 12 is a flow chart illustrating an exemplary process at a wireless communication device according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some examples, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein are methods and apparatus directed toward a process of receiving a channel state information configuration type and an identification of a channel state information report quantity associated with a first number of channel measurement resources (including NZP-CSI-RS resources and/or SSB resources). The process may utilize a user equipment device to report a quantization scheme that may be used to quantize the channel state information report quantity based on a total number of payload bits available to report the channel state information report quantity.

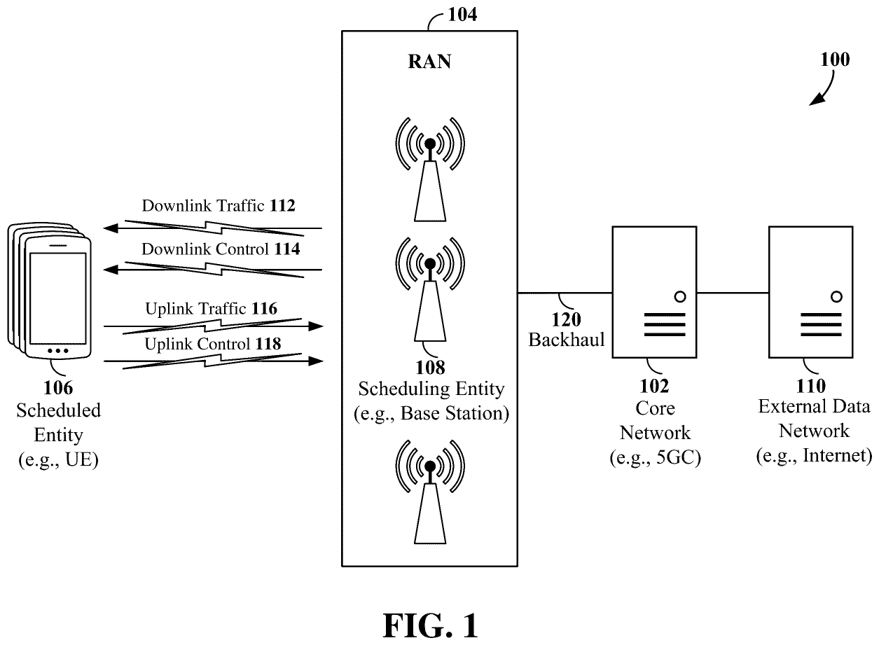

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF-chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control 118 and/or 118 information and/or uplink and/or downlink traffic 116 and/or 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC), or any other suitable standard or configuration.

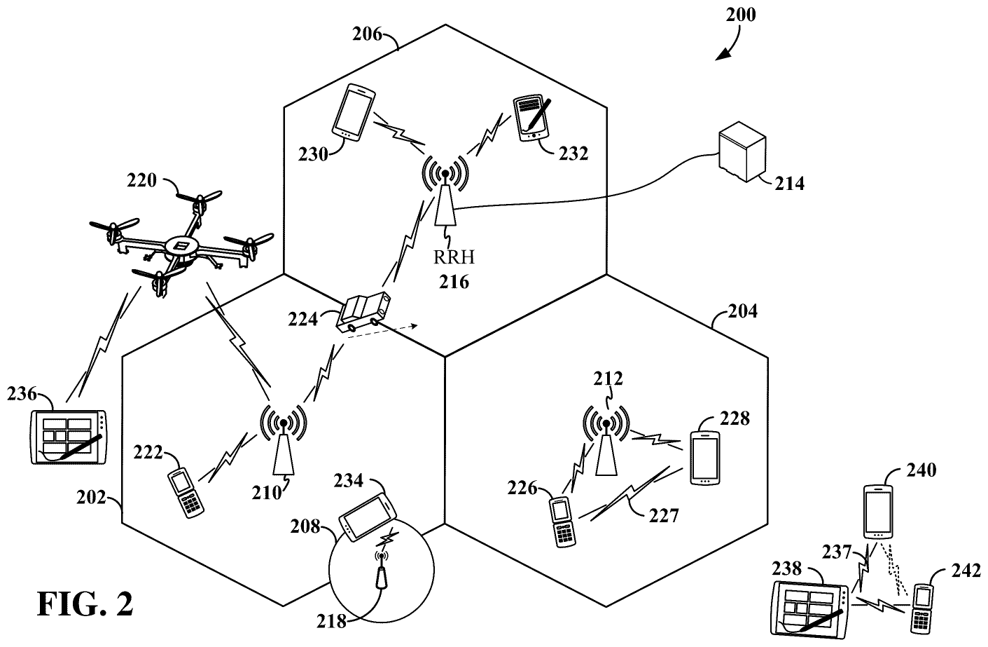

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full-duplex (SBFD), also known as flexible duplex.

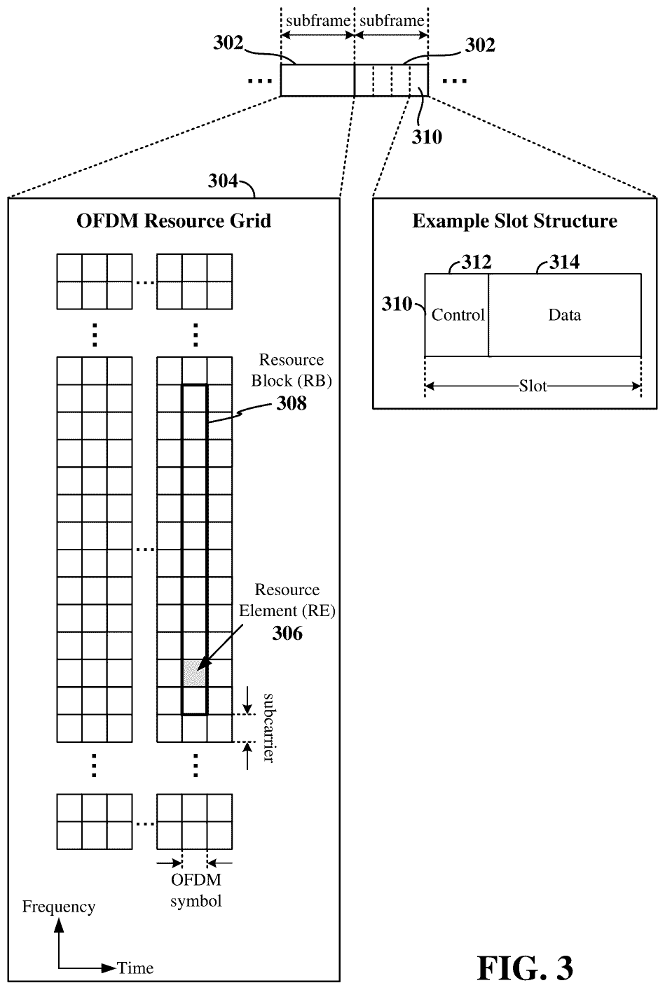

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid according to some aspects of the disclosure. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of

OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast,

or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIGS. 1, 2, and 3 are not necessarily all of the channels or carriers that may be utilized between devices, and those of ordinary skill in the art will recognize that other channels or carriers may be utilized in addition to those illustrated, such as other traffic, control, and feedback channels.

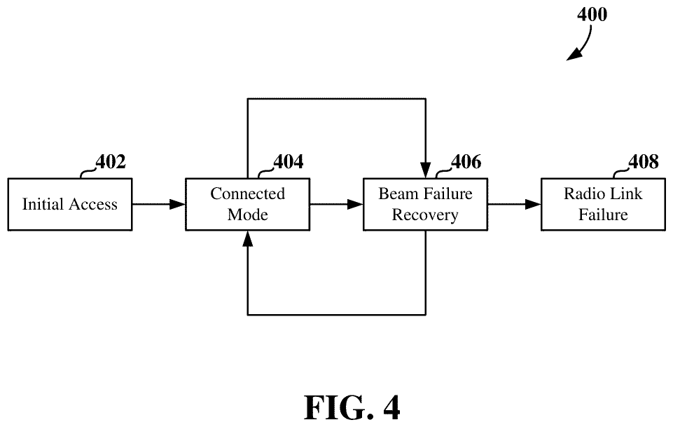

FIG. 4 is a schematic diagram 400 illustrating some aspects of beam management according to some aspects of the disclosure. A user equipment (not shown) (e.g., a UE, a wireless communication device) may obtain initial access 402 to a network via a network access node (not shown). The user equipment may be any user equipment or scheduled entity as shown and described, for example, in connection with FIGS. 1 and/or 2. The network access node may be any scheduling entity, network access node, or base station as shown and described, for example, in connection with FIGS. 1 and/or 2. In some examples, the network access node may be implemented as an aggregated base station or a disaggregated base station. In a disaggregated base station architecture, the network access node may include one or more of a central unit (CU), a distributed unit (DU), or a radio unit (RU).

To obtain initial access, the user equipment may enter into a random access channel (RACH) procedure. The UE and network access node may enter into a synchronization process during the RACH procedure. The network access node may transmit a plurality of synchronization signals during the synchronization process. Each synchronization signal may be transmitted in a corresponding plurality of downlink beams pointing in a corresponding plurality of directions. The process may be referred to as beam sweeping. In beam sweeping, the network access node sweeps its downlink beams by transmitting a downlink beam in a specific direction at a specific time, then transmitting a next downlink beam in a next direction at a next time, and so on. A different respective synchronization signal block (SSB) or channel state information reference signal (CSI-RS) may be used with each respective downlink beam during the beam sweeping procedure. The UE may evaluate the quality of the SSB or CSI-RS) of each of the different beams and select a beam with a best quality from among those beams being swept by the network access node. The user equipment may inform the network access node of the selection using, for example, a physical random access channel (PRACH) resource mapped to each respective downlink beam. The user equipment may utilize a CSI report to provide the network access node with an identity of the beam with the best quality. The beam sweep procedure may utilize relatively wide beams, referred to herein as Layer 1 (L1) beams.

According to one aspect, a process of beam management referred to herein as P1/P2/P3 may be practiced to refine the downlink beam direction. In short, during the P1 process, the network access node sweeps the L1 beams as described above and the user equipment selects the best beam and reports the identity of the best beam to the network access node, substantially as described above. During the P2 process, the network access node may refine the beam direction by sweeping narrower beams over narrower ranges and the user equipment may again select the best beam and report the identity of the (refined) best beam to the network access node. During the P3 process, if the user equipment supports beamforming, the network access node may fix the best beam identified by the user equipment (e.g., by repetitively transmitting the best beam identified by the user equipment) and the user equipment (utilizing its beamforming circuitry) may adjust its receive beam to effectively point in the direction of the network access node. There may be another process referred to herein as the U1/U2/U3 process, which may be a corresponding process but used to refine an uplink beam direction, but its explanation is omitted herein for the sake of brevity.

Upon successfully completing the random access procedure, the UE may enter a connected mode 404 with the network access node. From time to time, a beam failure may be detected and may be recovered from (as indicated by the clockwise arrows joining beam failure recovery 406 and connected mode 404.

Upon beam failure detection, the network access node may configure the user equipment with a beam failure detection reference signal. By way of example, the beam failure detection reference signal may be an SSB or a CSI-RS. The user equipment may declare a beam failure when a number of beam failure instance indications from the physical layer reach a configured threshold before a configured timer expires. SSB-based Beam Failure Detection is based on the SSB associated with the initial DL BWP. It can only be configured for the initial DL BWPs and DL BWPs containing the SSB associated with the initial DL BWP. For other DL BWPs, Beam Failure Detection can only be performed based on CSI-RS. The user equipment may trigger a beam failure recovery 406 by initiating a new random access procedure on a primary cell (PCell) in response to the user equipment detecting the beam failure on the PCell. Upon completing the random access procedure, beam failure recovery 406 for PCell is considered complete. A similar procedure may be followed for a secondary cell (SCell).

In some examples, a user equipment may not be able to recover a link after a beam failure occurs. For example, in an RRC connected mode (e.g., connected mode 404), a user equipment may perform radio link monitoring (RLM) in an active BWP based on reference signals (e.g., SSB and/or CSI-RS). By way of example and without limitation, a user equipment may enter into radio link failure 408 after the expiry of a radio problem timer started after indication of radio problems from the physical layer, after the expiry of a timer started upon triggering a measurement report for a measurement identity for which the timer has been configured while another radio problem timer is running, after a random access procedure failure, or after a radio link control (RLC) failure. Other criteria may also cause a user equipment to enter into a radio link failure 408.

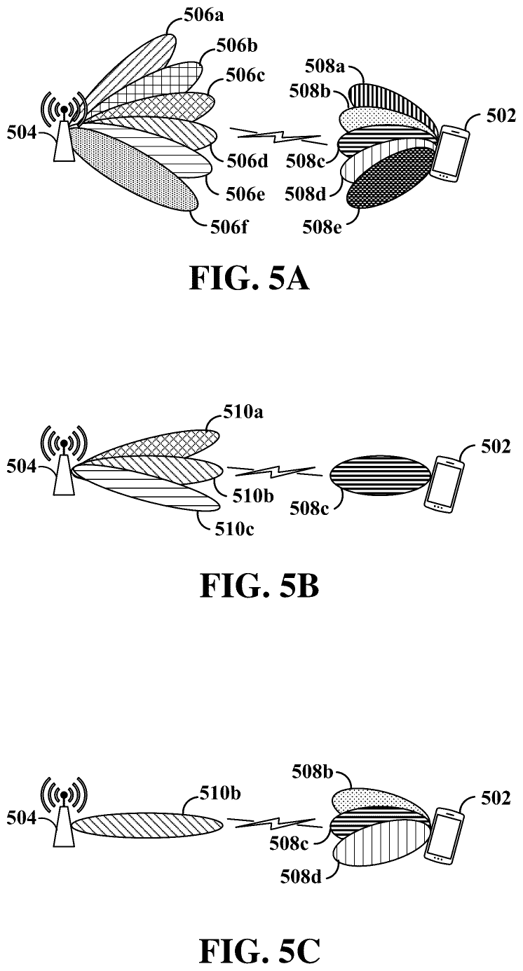

FIGS. 5A, 5B, and 5C are diagrams illustrating examples of downlink beam management procedures, including downlink beam refinement procedures, between a network entity 504 and a UE 502 according to some aspects. The network entity 504 may be any of the base stations (e.g., gNBs) or scheduling entities illustrated in FIGS. 1 and/or 2, and the UE 502 may be any of the UEs or scheduled entities illustrated in FIGS. 1 and/or 2. In some examples, the network entity 504 may be implemented as an aggregated base station or a disaggregated base station. In a disaggregated base station architecture, the network entity 504 may include one or more of a central unit (CU), a distributed unit (DU), or a radio unit (RU).

The network entity 504 may generally have the capability to communicate with the UE 502 using one or more transmit beams, and the UE 502 may further have the capability to communicate with the network entity 504 using one or more receive beams. As used herein, the term transmit beam refers to a beam on the network entity 504 that may be utilized for downlink or uplink communication with the UE 502. In addition, the term receive beam refers to a beam on the UE 502 that may be utilized for downlink or uplink communication with the network entity 504.

In the example shown in FIG. 5A, the network entity 504 is configured to generate a plurality of transmit beams 506a-506f, each associated with a different spatial direction. Each of the transmit beams 506a-506f may be referenced by a respective beam ID (e.g., an SSB resource indicator (SRI)). In addition, the UE 502 is configured to generate a plurality of receive beams 508a-508e, each associated with a different spatial direction. Each of the receive beams 508a-508e may further be referenced by a respective beam ID (e.g., via a QCL relation to an SSB resource indicator (SRI), CSI-RS resource indicator (CRI), or SRS resource indicator (SRI)). In some examples, the transmit beams 506a-506h on the network entity 504 and the receive beams 508a-508e on the UE 502 may be spatially directional mmWave beams, such as FR2, FR4-a, FR4-1, FR4, or FR5 beams. It should be noted that while some beams are illustrated as adjacent to one another, such an arrangement may be different in different aspects. For example, transmit beams 506a-506f transmitted during a same symbol may not be adjacent to one another. In some examples, the network entity 504 and UE 502 may each transmit more or less beams distributed in all directions (e.g., 360 degrees) and in three-dimensions. In addition, the transmit beams 506a-506f may include beams of varying beam width. For example, the network entity 504 may transmit certain signals (e.g., SSBs) on wider beams and other signals (e.g., CSI-RSs) on narrower beams.

The network entity 504 and UE 502 may select one or more transmit beams 506a-506f on the network entity 504 and one or more receive beams 508a-508e on the UE 502 for communication of uplink and downlink signals therebetween using a beam management procedure. In one example, as shown in FIG. 5A, during initial cell acquisition, the UE 502 may perform a P1 beam management procedure to scan the plurality of transmit beams 506a-506f transmitted in a wide range beam sweep on the plurality of receive beams 508a-508e to select a beam pair link (e.g., one of the transmit beams 506a-506f and one of the receive beams 508a-508e) for a physical random access channel (PRACH) procedure for initial access to the cell. For example, periodic SSB beam sweeping may be implemented on the network entity 504 at certain intervals (e.g., based on the SSB periodicity). Thus, the network entity 504 may be configured to sweep or transmit an SSB on each of a plurality of wider transmit beams 506a-506f. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam. The selected transmit beam and receive beam form a beam pair link (BPL) for the PRACH procedure. Here, the selected transmit beam may be associated with a particular RACH occasion that may be utilized by the UE 502 to transmit a PRACH preamble. In this way, the network entity 504 is informed of the selected transmit beam.

After completing the PRACH procedure, as shown in FIG. 5B, the network entity 504 and UE 502 may perform a P2 beam management procedure for beam refinement. For example, the network entity 504 may be configured to sweep or transmit a CSI-RS on each of a plurality of narrower transmit beams 510a-510c in a narrow range beam sweep for beam refinement. For example, each of the CSI-RS beams may have a narrower beam width than the SSB beams, and thus the transmit beams 510a-510c transmitted during the P2 procedure may each be a sub-beam of an SSB transmit beam selected during the P1 procedure (e.g., within the spatial direction of the SSB transmit beam). Transmission of the CSI-RS transmit beams may occur periodically (e.g., as configured via radio resource control (RRC) signaling by the gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). The UE 502 is configured to scan the plurality of CSI-RS transmit beams 510a-510c on one or more of the plurality of receive beams. In the example shown in FIG. 5B, the UE 502 scans the CSI-RS transmit beams 510a-510c on a single receive beam 508c selected during the P1 procedure. The UE 502 then performs beam measurements (e.g., RSRP, SINR, etc.) of the transmit beams 510a-510c on the receive beam 508c to determine the respective beam quality of each of the transmit beams 510a-510c.

The UE 502 can then generate and transmit a Layer 1 (L1) measurement report (e.g., L1-RSRP or L1-SINR report), including the respective beam ID (e.g., CSI-RS resource indicator (CRI)) and beam measurement (e.g., RSRP) of one or more of the CSI-RS transmit beams 510a-510c to the network entity 504. The network entity 504 may then select one or more CSI-RS transmit beams on which to communicate with the UE 502. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 502 may further refine the receive beam for each selected serving CSI-RS transmit beam to form a respective refined BPL for each selected serving CSI-RS transmit beam. For example, as shown in FIG. 5C, the UE 502 may perform a P3 beam management procedure to refine the UE-beam of a BPL. In an example, the network entity 504 may repeat transmission of a selected transmit beam 510b selected during the P2 procedure to the UE 502. The UE 502 can scan the transmit beam 510b using different receive beams 508b-508d to obtain new beam measurements for the selected CSI-RS transmit beam 510b and select the best receive beam to refine the BPL for transmit beam 510b. In some examples, the selected receive beam to pair with a particular CSI-RS transmit beam 510b may be the receive beam on which the highest RSRP for the particular CSI-RS transmit beam is measured.

In some examples, in addition to configuring the UE 502 to perform P2 beam refinement (e.g., CSI-RS beam measurements), the network entity 504 may configure the UE 502 to perform a P1 beam management procedure (e.g., SSB beam measurements) outside of a RACH procedure and to provide an L1 measurement report containing beam measurements of one or more SSB transmit beams 506a-506f as measured on one or more of the receive beams 508a-508e. In this example, the L1 measurement report may include multiple RSRPs for each transmit beam, with each RSRP corresponding to a particular receive beam to facilitate selection of BPL(s). For example, the network entity 504 may configure the UE 502 to perform SSB beam measurements and/or CSI-RS beam measurements for various purposes, such as beam failure detection (BFD), beam failure recovery (BFR), cell reselection, beam tracking (e.g., for a mobile UE 502 and/or network entity 504), or other beam optimization purpose.

In one example, a single CSI-RS transmit beam (e.g., beam 510b) on the network entity 504 and a single receive beam (e.g., beam 508c) on the UE may form a single BPL used for communication between the network entity 504 and the UE 502. In another example, multiple CSI-RS transmit beams (e.g., beams 510a, 510b, and 510c) on the network entity 504 and a single receive beam (e.g., beam 508c) on the UE 502 may form respective BPLs used for communication between the network entity 504 and the UE 502. In another example, multiple CSI-RS transmit beams (e.g., beams 510a, 510b, and 510c) on the network entity 504 and multiple receive beams (e.g., beams 508c and 508d) on the UE 502 may form multiple BPLs used for communication between the network entity 504 and the UE 502. In this example, a first BPL may include transmit beam 510b and receive beam 508c, a second BPL may include transmit beam 510a and receive beam 508c, and a third BPL may include transmit beam 510c and receive beam 508d.

In addition to L1 measurement reports, the UE 502 can further utilize the beam reference signals to estimate the channel quality of the channel between the network entity 504 and the UE 502. For example, the UE 502 may measure the SINR of each received CSI-RS and generate a CSI report based on the measured SINR. The CSI report may include, for example, a channel quality indicator (CQI), rank indicator (RI), precoding matrix indicator (PMI), and/or layer indicator (LI). The scheduling entity may use the CSI report to select a rank for the scheduled entity, along with a precoding matrix and a MCS to use for future downlink transmissions to the scheduled entity. The MCS may be selected from one or more MCS tables, each associated with a particular type of coding (e.g., polar coding, LDPC, etc.) or modulation (e.g., binary phase shift keying (BPSK), quadrature phase shift keying (QPSK), 16 quadrature amplitude modulation (QAM), 64 QAM, 256 QAM, etc.). The LI may be utilized to indicate which column of the precoding matrix of the reported PMI corresponds to the strongest layer codeword corresponding to the largest reported wideband CQI.

To distinguish between the different types of reports (including CSI reports and L1 measurement reports) and different types of measurements, the network entity 504 may configure the UE 502 with one or more report settings. Each report setting may be associated with a reference signal configuration indicating a configuration of one or more reference signals (e.g., CSI-RSs) for use in generating the CSI report. In some examples, a report setting may be associated with a combined reference signal configuration.

In some examples, artificial intelligence (AI) and machine learning (ML) may be applied to various use cases involving the air-interface between a user equipment (e.g., user equipment 504 as shown and described in connection with FIG. 5) and a network access node (e.g., network access node 502 as shown and described in connection with FIG. 5). AI/ML may be used to improve performance, reduce, or better manage, complexity, for example.

Some use cases may relate to CSI feedback. For example, possible uses of AI/ML in connection with CSI feedback may enhance CSI feedback by reducing overhead, improving accuracy, and enabling prediction or enhanced prediction capabilities.

AI/ML may also be used in connection with beam management. For example, AI/ML may contribute to beam prediction in the time domain, and/or in the spatial domain for overhead and latency reduction and/or beam selection accuracy improvement.

AI/ML may also be used in connection with positioning accuracy enhancements for different scenarios including, e.g., those with heavy non-line-of-sight (NLOS) conditions.

In order to finalize representative sub use cases for each use case, and to help in characterization and establishment of baseline performance evaluations, the AI/ML approaches for sub use cases should be diverse. The diversity may benefit decisions being made with regard to, for example, various requirements involving collaboration of user equipment and network access nodes.

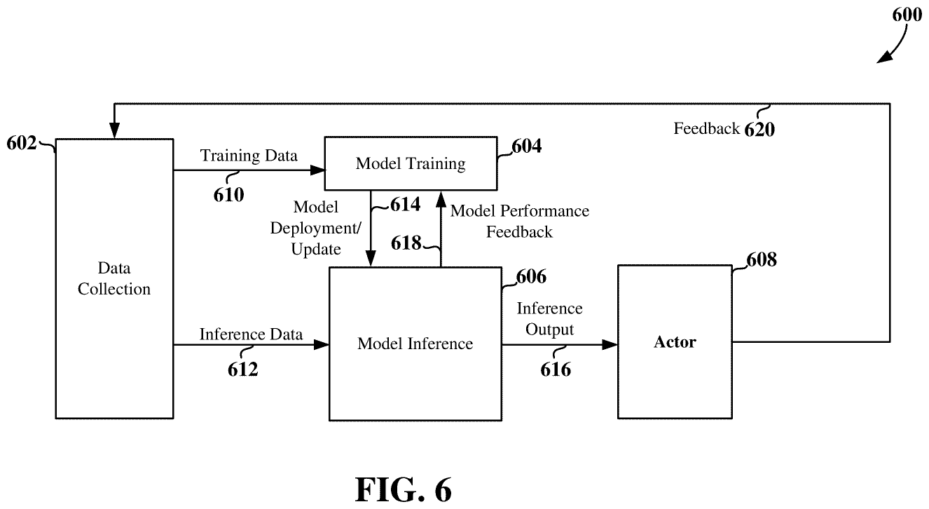

FIG. 6 is a block diagram depicting a use of artificial intelligence and/or machine learning in the collection of data according to some aspects of the disclosure. The circuitry/function represented in FIG. 6 may be utilized in connection with new radio (NR) and 5G Evolved Universal Terrestrial Radio Access (E-UTRA)-NR Dual Connectivity (EN-DC). In FIG. 6, data collection 602 may be a circuit/function that provides input data to model training 604 and model inference 606 circuits/functions. Artificial intelligence/machine learning (AI/ML) algorithm-specific data preparation (e.g., data pre-processing and cleaning, formatting, and transformation) may not be carried out in the data collection 602 circuit/function.

Examples of input data may include but are not limited to measurements from UEs or different network entities, feedback from the actor circuit/function, and output from an AI/ML model.

Training Data 610 may be data used as input for the AI/ML model training 604 circuit/function.

Inference Data 612 may be used as input for the AI/ML model inference 606 circuit/function.

Model Training 604 may be a circuit/function that performs the ML model training, validation, and testing, which may generate model performance metrics as part of a model testing procedure. The model training 604 circuit/function may also be responsible for data preparation (e.g., data pre-processing and cleaning, formatting, and transformation) based on training data 610 delivered by the data collection 602 circuit/function, if required.

Model Deployment/Update 614 may be used to initially deploy a trained, validated, and tested AI/ML model to the model inference 606 circuit/function or to deliver an updated model to the model inference 606 circuit/function.

Model Inference 606 circuit/function may provide AI/ML model inference output (e.g., predictions or decisions). In some examples, the model inference 606 circuit/function may provide model performance feedback to the model training 604 circuit/function. The model inference 606 circuit/function may also be responsible for data preparation (e.g., data pre-processing and cleaning, formatting, and transformation) based on inference data 612 delivered by the data collection 602 circuit/function, if required.

The output of the circuit/function 600 of FIG. 6 may be the inference output 616 of the AI/ML model produced by the model inference 606 circuit/function. According to some aspects, the details of the inference output 616 may be use case specific.

The model performance feedback 618 may be applied if certain information derived from the model inference 606 circuit/function is suitable for improvement of the AI/ML model trained in the model training 604 circuit/function. Feedback 620 from the actor 608 circuit/function or other network entities (e.g., via the data collection 602 circuit/function) may be used at the model inference 606 circuit/function to create the model performance feedback 618.

The actor 608 circuit/function may receive the output from the model inference 606 circuit/function and may trigger or perform corresponding actions. The actor 608 circuit/function may trigger actions directed to other entities or to itself.

AI/ML-based predictive beam management may be employed according to some aspects of the disclosure. AI/ML is well suited to beam management aspects because beam qualities and failures are identified via measurements. Without AI/ML, improvements in beam management may be associated with additional power needs and additional overhead to achieve improved performance. In some solutions without AI/ML, beam accuracy may be limited due to power and/or overhead restrictions. With non-AI/ML aspects, latency and/or throughput are adversely impacted by beam resuming efforts (beam recovery efforts).

However, the use of AI/ML in predictive beam management (e.g., in the spatial domain, the time domain, and/or the frequency domain) may lead to reductions in power usage, reduction in overhead, and improved performance in connection with accuracy, latency, and/or throughput.

Predictive beam management (e.g., AI/ML based predictive beam management) may be used to predict non-measured beam qualities (which may lower power/overhead and/or may improve accuracy). Predictive beam management may also predict future beam blockage and/or beam failure (which may result in improved latency and/or throughput).

Beam prediction is a highly non-linear problem. For example, predicting future transmit beam qualities may depend on a UE's speed and/or trajectory, depend on which receive beams are used or may be used, and/or depend on interference. The preceding list is exemplary and not limiting. Other aspects may also affect beam prediction. These types of variables may be difficult to modeled via conventional statistical signaling processing methods.

According to some aspects, beam prediction using AI/ML may occur at the UE or at the network access node. In some aspects, determining where to employ AI/ML based beam prediction procedures may involve a tradeoff between UE performance and UE power. For example, to predict future downlink transmit (DL-Tx) beam qualities, a UE may need to perform more observations (via measurements) than a network access node (via UE feedback). Consequently, while prediction at the UE may outperform prediction at the network access node, prediction at the UE may come at the cost of increased power consumption (due to the measurements/inference efforts taking place at the UE).

Similarly, AI/ML training may occur at either the network or the UE. Deciding where training may occur may involve a comparison between the effort utilized for data collection and the effort utilized in association with the increased UE computational needs. By way of example, training at the network may entail enhanced data collection via the air interface or via application layer approaches. On the other hand, and by way of example, training at the UE may entail additional UE computation and buffering efforts that may be needed in conjunction with model training and storage of volumes of data, not presently stored at the UE.

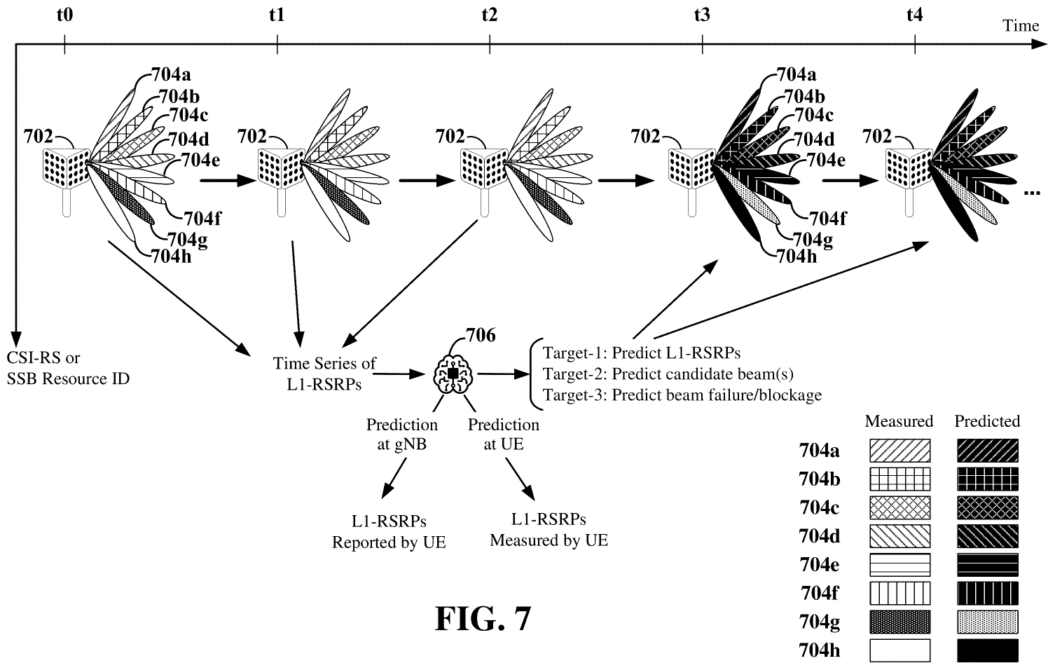

FIG. 7 is a schematic diagram representing a periodic state and periodic measurements of a plurality of beams 704a-704h at one gNB 702 (e.g., a network access node, a scheduling entity) over time according to some aspects of the disclosure. The gNB 702 may transmit a plurality of CSI-RS or SSB resource identifiers. Each of the plurality of antenna beams 704a-704h is associated with a unique CSI-RS or SSB resource identifier value. As shown, at time t0, a first set of L1-RSRPs are input to a machine learning model 706. At time t1, a second set of L1-RSRPs are input to the machine learning model 706. At time t3, a third set of L1-RSRPs are input to the machine learning model 706. If the machine learning model 706 is located at the gNB 702, the prediction output by the machine learning model 706 may be based on the L1-RSRPs that were reported over time by a given UE (not shown). If the machine learning model 706 is located at the given UE (not shown), the prediction output by the machine learning model 706 may be based on the L1-RSRPs that were measured over time by the given UE (not shown). The machine learning model 706 may output three target predictions in either case. Target-1 may predict the L1 RSRPs are times t3 and t4. Target-2 may predict the candidate beam(s) at times t3 and t4. Target-3 may predict beam failure or beam blockage at times t3 and t4. The three target predictions may have the benefit of reducing UE power usage, because the UE may rely on predictions, rather than measurements at times t3 and t4. The three target predictions may have the benefit of allowing for a reduction in UE-specific reference signal overhead, because UE-specific reference signal would not need to be transmitted by the gNB 702 at times t3 and t4, also because the UE may rely on predictions, rather than measurements at times t3 and t4.

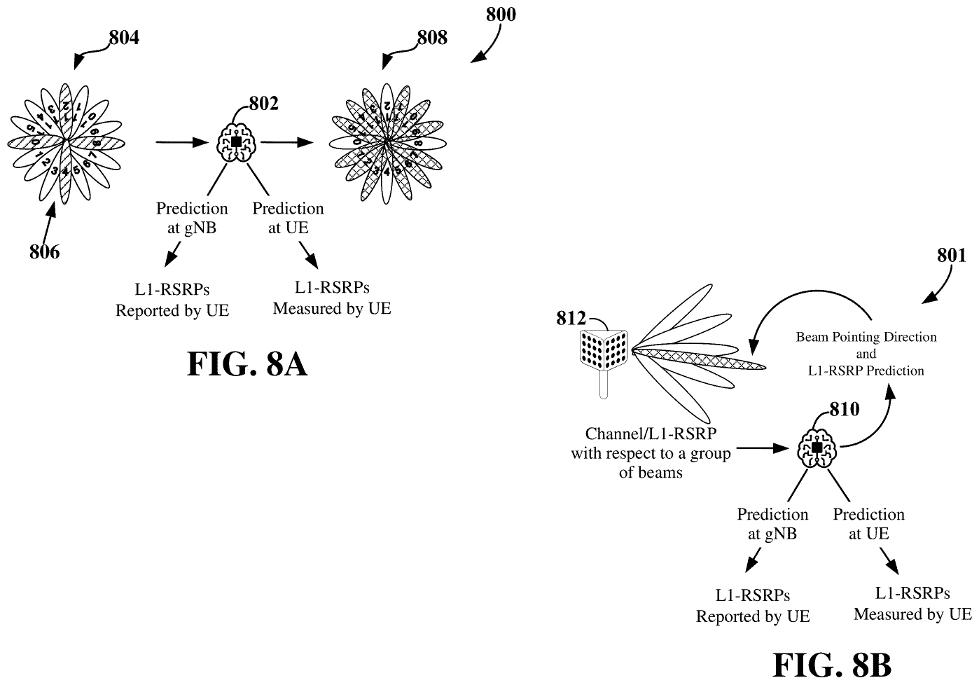

FIGS. 8A and 8B are schematic diagrams representing explicit 800 and implicit 801 spatial diversity beam prediction, respectively, according to some aspects of the disclosure. In FIG. 8A, the machine learning model 802 may receive as input the L1-RSRPs of a first group of beams 804. If the machine learning model 802 is located at a gNB 806 (represented generally by the center of the first group of beams 804, the prediction, output by the machine learning model 802 may be based on the L1-RSRPs that were reported by a given UE (not shown). If the machine learning model 802 is located at the given UE, the prediction, the prediction output by the machine learning model 802 may be based on the L1-RSRPs that were measured by the given UE (not shown). In either case, the machine learning model 802 may output a prediction regarding the L1-RSRPs of a second group of beams 808. At least one benefit of the procedure shown in FIG. 8A is a reduced number of beam measurements required of the UE (because the L1-RSRPs of the second group of beams 808 is predicted, not measured). This may result in reduced power consumption at the UE.

In FIG. 8B, the machine learning model 810 may receive as input various channel/L1-RSRPs with respect to a group of beams. If the machine learning model 810 is located at a gNB 812, the prediction, output by the machine learning model 810, may be based on the input of the channel/L1-RSRPs reported by a given UE (not shown). If the machine learning model 810 is located at the given UE, the prediction, output by the machine learning model 810, may be based on the input of the channel/L1-RSRPs that the given UE measured. In either case, the machine learning model 810 may predict a beam pointing direction of a given beam and an L1-RSRPs prediction of the same beam, for example. The predictions may be based on a linear combination of the group of beams or on an explicit pointing direction. At least one benefit of the procedure described in connection with FIG. 8B is that there is better beam accuracy without the need of repeated beam sweeping procedures.

However, for certain ML-assisted predictive beam management use cases, where the predictions are made at the network access node, conventionally reporting the strongest L1-RSRPs may not be sufficient. For example, in order to make the prediction at the network access node via UE reported L1-RSRPs measurements, both the strongest L1-RSRPs and some less strong L1-RSRPs may be considered. In some aspects, the measurements of the less strong L1-RSRPs may have a higher effect on the accuracy of the prediction than the measurements of the strongest L1-RSRPs. In one example related to beam blockage prediction (where the prediction is made at the network access node), a vectorized L1-RSRP fingerprint time series may be used to predict blockage instance/severity/direction, and in at least this one example, the less strong L1-RSRPs may play a more important role in the prediction than the strongest L1-RSRPs.

Given a plurality of measured L1-RSRPs associated with different respective beams at a certain time instance, a UE may have better insight on which of the plurality of measured L1-RSRPs should be reported and/or may have better insight as to how to quantize the measured L1-RSRPs for reporting For example, when the measured L1-RSRPs exhibit a small variance, it may be better to use a fewer number of bits per beam with small dynamic range for differential quantization. In that way, the UE may be able to report as many L1-RSRPs as possible (within a given payload size limitation on the number of bits per report). By way of another example, when the measured L1-RSRPs exhibit a large variance, it may be better to use a greater number of bits per beam with large dynamic range for differential quantization. In that way, the UE may be able to report a number of representative L1-RSRPs.

Aspects described herein may support ML-assisted predictive beam management, at least based upon signaling that may allow a UE to adaptively determine and report L1-RSRP quantization schemes, given a certain payload size limitation.

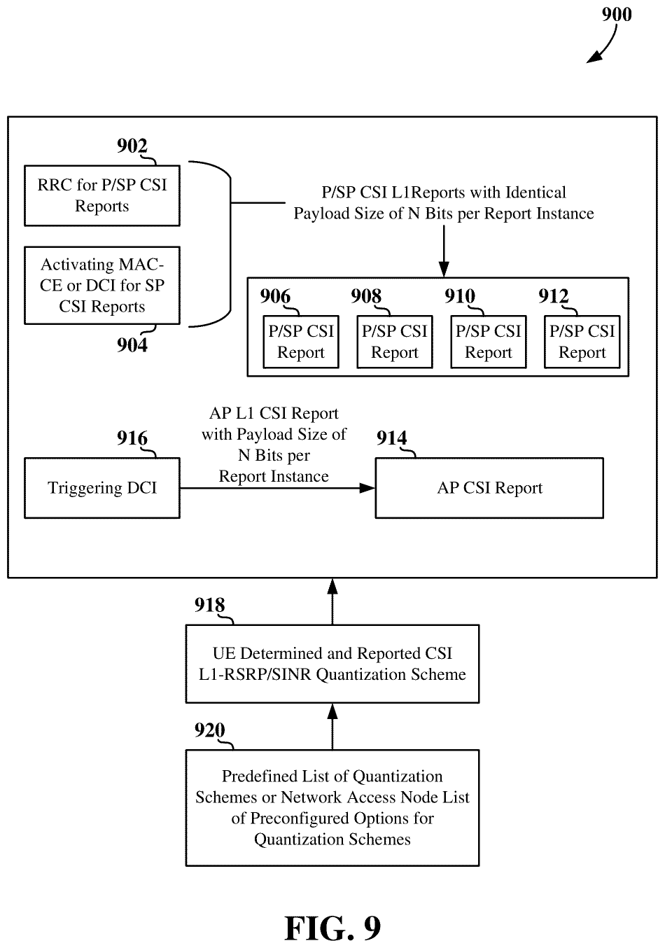

FIG. 9 is a schematic representation of network access node configured or indicated periodic/semipersistent/aperiodic channel state information (CSI) reports 900 according to some aspects of the disclosure. As depicted, periodic (P) or semipersistent (SP) CSI L1 reports may be RRC configured 902, and SP-CSI L1 reports may be activated by a MAC-CE or by DCI 904. The P or SP (P/SP) CSI L1 reports 906, 908, 910, 912 may each have an identical payload size of N bits per report instance. Also, as depicted, an aperiodic (AP) CSI LI report 914 may be triggered by DCI 916. The AP CSI LI report 914 may also have a payload of N bits. Each of the P/SP CSI LI reports 906, 908, 910, 912, or the group of these P/SP CSI LI reports, and the AP CSI LI report 914 may each include a UE determined and reported L1-RSRP/SINR quantization scheme 918. The ue determined and reported L1-RSRP/SINR quantization scheme 918 may be selected from a predefined list of quantization schemes or a network access node list of preconfigured options for quantization schemes 920.

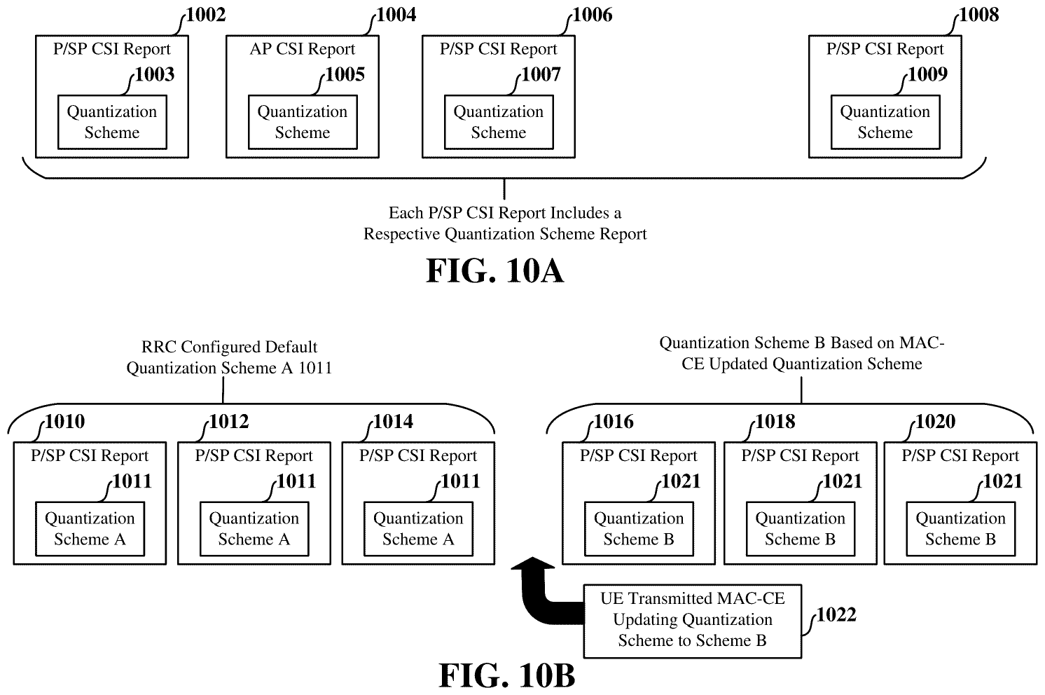

FIGS. 10A and 10B are schematic representations of two options of quantization scheme reporting according to some aspects of the disclosure. According to the first option depicted in FIG. 10A, each respective quantization scheme is reported together with a respective CSI report. This option applies to P, SP, and AP CSI reports. In other words, P/SP CSI report 1002 includes a respective quantization scheme report 1003, AP CSI report 1004 includes a respective quantization scheme report 1005, P/SP CSI report 1006 includes a respective quantization scheme report 1007, and P/SP CSI report 1008 includes a respective quantization scheme report 1009.

According to the second option of FIG. 10B, for P or SP CSI reports, a UE may determine and report a default quantization scheme (e.g., default quantization scheme A 1011) with P/SP CSI reports 1010, 1012, 1014. The default quantization scheme A 1011 may be an RRC configured quantization scheme. The UE may determine to switch to an alternative quantization scheme (e.g., quantization scheme B 1021). The UE may utilize a MAC-CE 1022 to report the alternative quantization scheme identification to a network access node. Upon the UE receiving a confirmation from the network access node (confirming receipt of the MAC-CE 1022), the UE may apply the alternative quantization scheme to P/SP CSI reports. For example, P/SP CSI reports 1010, 1012, 1014 each include quantization scheme A 1011. At a given time the UE transmits the MAC-CE 1022, signaling the intention to switch to the alternative quantization scheme (quantization scheme B 1021). After receipt of a confirmation of receipt of the MAC-CE 1022 from the network access node, the UE may switch to the reported alternative quantization scheme (quantization scheme B 1021) for the next applicable reporting instance (i.e., the reporting instance that includes P/SP CSI report 1016). Accordingly, after receiving the confirmation (or optionally after waiting for a duration that may be predefined (e.g., in a standard) or that may be network access node configured), P/SP CSI reports 1016, 1018, 1020 each include quantization scheme B 1021.

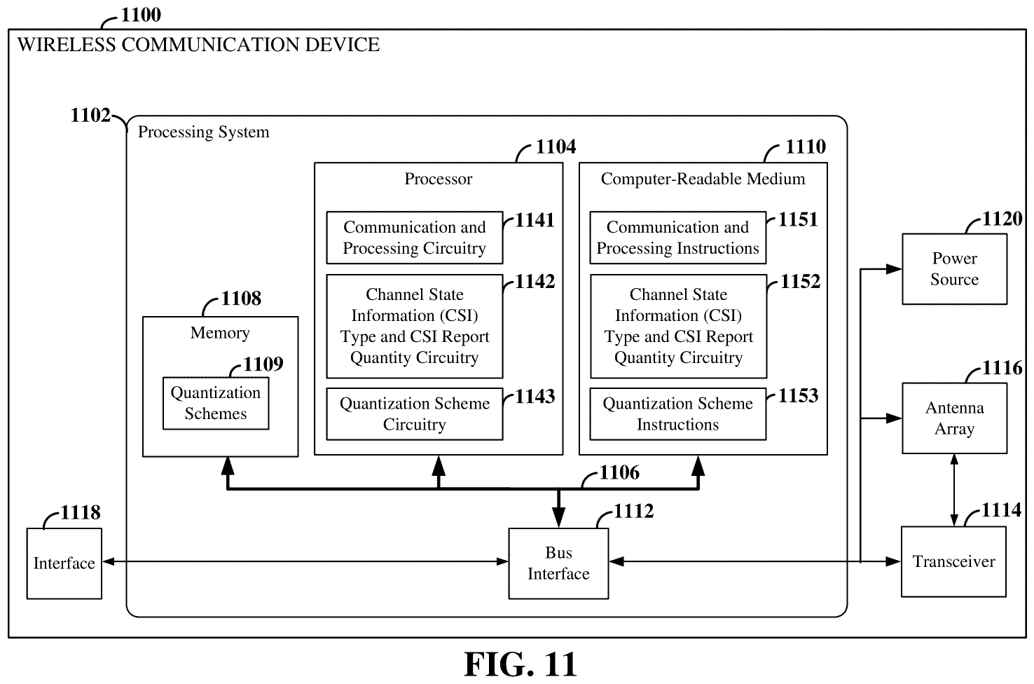

FIG. 11 is a block diagram illustrating an example of a hardware implementation of a wireless communication device 1100 (e.g., a UE) employing a processing system 1102 according to some aspects of the disclosure. The wireless communication device 1100 may be a scheduled entity (e.g., a UE) as illustrated in any one or more of FIGS. 1, 2, 5, 6, 7, and/or 8.

In accordance with various aspects of the disclosure, an element, or any portion of an element, or any combination of elements may be implemented with a processing system 1102 that includes one or more processors, such as processor 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1100 may be configured to perform any one or more of the functions described herein. That is, the processor 1104, as utilized in the wireless communication device 1100, may be used to implement any one or more of the methods or processes described and illustrated, for example, in any one or more of FIGS. 4 and/or 6.

The processor 1104 may, in some examples, be implemented via a baseband or modem chip and in other implementations, the processor 1104 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1102 may be implemented with a bus architecture, represented generally by the bus 1106. The bus 1106 may include any number of interconnecting buses and bridges depending on the specific application of the processing system 1102 and the overall design constraints. The bus 1106 communicatively couples together various circuits, including one or more processors (represented generally by the processor 1104), a memory 1108, and computer-readable media (represented generally by the computer-readable medium 1110). The bus 1106 may also link various other circuits such as timing sources, peripherals, voltage regulators, and power management circuits, which are well known in the art, and, therefore, will not be described any further.

A bus interface 1112 provides an interface between the bus 1106 and a transceiver 1114. The transceiver 1114 may be a wireless transceiver. The transceiver 1114 may provide a means for communicating with various other apparatus over a transmission medium (e.g., air interface). The transceiver 1114 may further be coupled to one or more antenna arrays (hereinafter antenna array 1116). The bus interface 1112 further provides an interface between the bus 1106 and a user interface 1118 (e.g., keypad, display, touch screen, speaker, microphone, control features, etc.). Of course, such a user interface 1118 is optional and may be omitted in some examples. In addition, the bus interface 1112 further provides an interface between the bus 1106 and a power source 1120 of the wireless communication device 1100.

The processor 1104 is responsible for managing the bus 1106 and general processing, including the execution of software stored on the computer-readable medium 1110. The software, when executed by the processor 1104, causes the processing system 1102 to perform the various functions described below for any particular apparatus. The computer-readable medium 1110 and the memory 1108 may also be used for storing data that is manipulated by the processor 1104 when executing software. The data may include data in look-up table(s) 1109, such as listings of quantization schemes and default quantization schemes as described above according to some aspects of the disclosure.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1110. When executed by the processor 1104, the software may cause the processing system 1102 to perform the various processes and functions described herein for any particular apparatus.

The computer-readable medium 1110 may be a non-transitory computer-readable medium and may be referred to as a computer-readable storage medium or a non-transitory computer-readable medium. The non-transitory computer-readable medium may store computer-executable code (e.g., processor-executable code). The computer-executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1110 may reside in the processing system 1102, external to the processing system 1102, or distributed across multiple entities including the processing system 1102. The computer-readable medium 1110 may be embodied in a computer program product or article of manufacture. By way of example, a computer program product or article of manufacture may include a computer-readable medium in packaging materials. In some examples, the computer-readable medium 1110 may be part of the memory 1108. Those skilled in the art will recognize how best to implement the described functionality presented throughout this disclosure depending on the particular application and the overall design constraints imposed on the overall system.

In some aspects of the disclosure, the processor 1104 may include communication and processing circuitry 1141 configured for various functions, including, for example, communicating with other wireless communication devices (e.g., a scheduling entity, a scheduled entity), a network core (e.g., a 5G core network), or any other entity, such as, for example, local infrastructure or an entity communicating with the wireless communication device 1100 via the Internet, such as a network provider. In some examples, the communication and processing circuitry 1141 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1141 may include one or more transmit/receive chains.

In some implementations where the communication involves receiving information, the communication and processing circuitry 1141 may obtain or identify information from a component of the wireless communication device 1100 (e.g., from the transceiver 1114 that receives the information via radio frequency signaling or some other type of signaling suitable for the applicable communication medium), process (e.g., decode) the information, and output the processed information. For example, the communication and processing circuitry 1141 may output the information to another component of the processor 1104, to the memory 1108, or to the bus interface 1112. In some examples, the communication and processing circuitry 1141 may receive one or more of: signals, messages, other information, or any combination thereof. In some examples, the communication and processing circuitry 1141 may receive information via one or more channels. In some examples, the communication and processing circuitry 1141 may include functionality for a means for receiving. In some examples, the communication and processing circuitry 1141 may include functionality for a means for processing, including a means for demodulating, a means for decoding, etc.

In some implementations where the communication involves sending (e.g., transmitting) information, the communication and processing circuitry 1141 may obtain or identify information (e.g., from another component of the processor 1104, the memory 1108, or the bus interface 1112), process (e.g., modulate, encode, etc.) the information, and output the processed information. For example, the communication and processing circuitry 1141 may obtain data stored in the memory 1108 and may process the obtained data according to some aspects of the disclosure.

In some examples, the communication and processing circuitry 1141 may obtain information and may output the information to the transceiver 1114 (e.g., that transmits the information via radio frequency signaling or some other type of signaling suitable for the applicable communication medium). In some examples, the communication and processing circuitry 1141 may send one or more of signals, messages, other information, or any combination thereof. In some examples, the communication and processing circuitry 1141 may send information via one or more channels. In some examples, the communication and processing circuitry 1141 may include functionality for a means for sending (e.g., a means for transmitting). In some examples, the communication and processing circuitry 1141 may include functionality for a means for generating, including a means for modulating, a means for encoding, etc. In some examples, the communication and processing circuitry 1141 may be configured to receive and process uplink traffic and uplink control messages (e.g., similar to uplink traffic 116 and uplink control 118 of FIG. 1) and process and transmit downlink traffic and downlink control messages (e.g., similar to downlink traffic 112 and downlink control 114 of FIG. 1) via the antenna array 1116 and the transceiver 1114.

The communication and processing circuitry 1141 may further be configured to execute communication and processing instructions 1151 (e.g., software) stored on the computer-readable medium 1110 to implement one or more functions described herein.

In some aspects of the disclosure, the processor 1104 may include channel state information (CSI) type and CSI report quantity circuitry 1142. The CSI type and CSI report quantity circuitry 1142 may be configured for various functions, including, for example, receiving a CSI configuration type and an identification of a CSI report quantity associated with a first number of channel measurement resources (CMRs) (including, for example, NZP-CSI-RS resources and/or SSB resources). In some examples, the CSI configuration type may be periodic (P), aperiodic (AP), or semipersistent (SP). In some examples, the CSI configuration type and the identification of the CSI report quantity are received from a network and the quantization scheme is reported to the network. In some examples the CSI report quantity may be at least one of: a reference signal received power (RSRP), a reference signal received quality (RSRQ), or a signal to interference plus noise ratio (SINR). In aspects where the CSI report quantity is an RSRP, the RSPR may be a layer 1-RSRP (L1-RSRP). The CSI type and CSI report quantity circuitry 1142 may be configured to execute CSI type and CSI report quantity instructions 1152 (e.g., software) stored on the computer-readable medium 1110 to implement one or more functions described herein.

In some aspects of the disclosure, the processor 1104 may quantization scheme circuitry 1143. The quantization scheme circuitry 1143 may be configured for various functions, including, for example, reporting a quantization scheme to quantize the CSI report quantity based on a total number of payload bits available to report the CSI report quantity. According to some aspects, the quantization scheme circuitry 1143 may further receive the total number of payload bits via radio resource control (RRC) signaling in response to the CSI configuration type being periodic. In some examples, the quantization scheme circuitry 1143 may further receive, in response to the CSI configuration type being semipersistent, the total number of payload bits via at least one of: radio resource control (RRC) signaling that configured a CSI report, a medium access control-control element (MAC-CE) that activated the CSI report, or a first downlink control information (DCI) that triggered the CSI report. In other examples, the quantization scheme circuitry 1143 may further receive the total number of payload bits via a DCI that triggered the CSI report, in response to the CSI configuration type being aperiodic. In still other examples, the quantization scheme circuitry 1143 may select the quantization scheme from a standardized predefined list or a set of quantization scheme options preconfigured at a base station. According to some aspects, the quantization scheme circuitry 1143 may at least one of: report for each respective layer 1-RSRP (L1-RSRP) or respective signal to interference plus noise (SINR) of the first number of CMRs, whether a reported value of the respective L1-RSRP or the respective SINR is an absolute value or a differential value, or report for each respective L1-RSRP or respective SINR of the first number of CMRs, a quantity of a number of bits used to quantize the respective L1-RSRP or the respective SINR. According to some aspects, the quantization scheme circuitry 1143 may further identify the respective L1-RSRP or the respective SINR that serves as a basis for the differential value in a given reporting instance, in response to the reported value being the differential value. Still further, the quantization scheme circuitry 1143 may report a dynamic range of the quantization scheme and a step-size between adjacent L1-RSRP or SINR codepoints in a given reporting instance, in addition to reporting the quantity of the number of bits used to quantize the respective L1-RSRP or the respective SINR. According to some examples, in response to the CSI configuration type being periodic, the quantization scheme may be configured by an associated CSI report setting and, alternatively, in response to the CSI configuration type being semipersistent or aperiodic, the quantization scheme may be selected from a plurality of quantization schemes that are pre-configured by the associated CSI report setting. In some examples, the quantization scheme circuitry 1143 may limit a range of the quantization scheme to a subset of the plurality of quantization schemes that are pre-configured by the associated CSI report setting in response to the CSI configuration type being semipersistent or aperiodic and a medium access control-control element (MAC-CE) activating the semipersistent CSI report or a downlink control information (DCI) triggering the aperiodic CSI report.

According to some examples, the quantization scheme circuitry 1143 may report the quantization scheme together with a CSI report in response to the CSI configuration type being periodic, semipersistent, or aperiodic, or the quantization scheme circuitry 1143 may report the quantization scheme via a medium access control-control element (MAC-CE) in response to the CSI configuration type being periodic or semipersistent. In such examples, the quantization scheme may be reported via the MAC-CE and the quantization scheme may be a default quantization scheme. According to those aspects, the quantization scheme circuitry 1143 may further report a value in the MAC-CE that indicates that the default quantization scheme is used. In aspects where the quantization scheme is reported via the MAC-CE, the quantization scheme circuitry 1143 may further identify the alternative quantization scheme in the MAC-CE in response to determining to use an alternative quantization scheme, different from the default quantization scheme. The quantization scheme circuitry 1143 may still further receive a confirmation indicating receipt of the MAC-CE and may apply the alternative quantization scheme during a remainder of a reporting instance and onward in time until notified to use a next quantization scheme. According to some aspects, the quantization scheme circuitry 1143 may report the first number of CMRs. In response to the CSI configuration type being periodic or semipersistent, the quantization scheme circuitry 1143 may report the first number of CMRs by at least one of: reporting an identifier of an option selected from a plurality of options preconfigured to the wireless communication device by a network access node, reporting the first number of CMRs using a second number of bits based on the first number of CMRs associated with a CSI report, reporting the first number of CMRs together with the CSI report, or reporting a default value of the first number of CMRs. In response to the CSI configuration type being aperiodic, the quantization scheme circuitry 1143 may report the first number of CMRs by at least one of: reporting an identifier of the option selected from the plurality of options preconfigured to the wireless communication device by the network access node, reporting the first number of CMRs using the second number of bits based on the first number of CMRs associated with the CSI report, or reporting the first number of CMRs together with the CSI report.

The quantization scheme circuitry 1143 may be configured to execute quantization scheme instructions 1153 (e.g., software) stored on the computer-readable medium 1110 to implement one or more functions described herein.

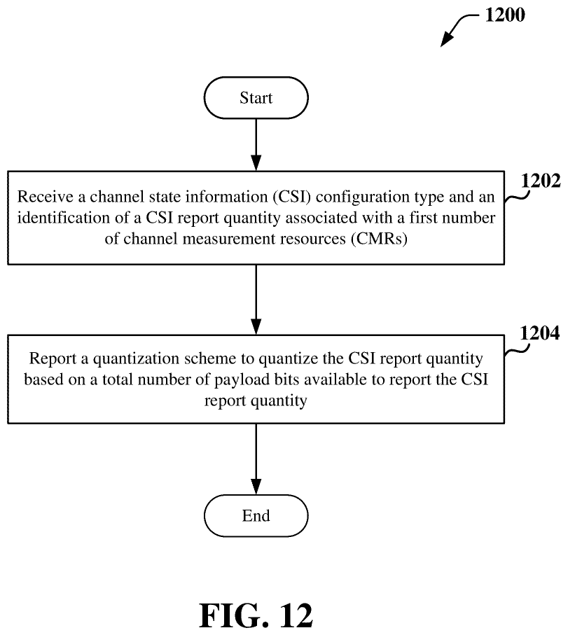

FIG. 12 is a flow chart illustrating an exemplary process 1200 (e.g., a method of wireless communication) at a wireless communication device (e.g., a scheduled entity, a user equipment (UE)) according to some aspects of the disclosure. The process 1200 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 1200 may be carried out by the wireless communication device 1100 described and illustrated in connection with FIG. 11. In some examples, the process 1200 may be carried out by any suitable apparatus or means for carrying out the functions or algorithms described herein.

At block 1202, the wireless communication device may receive a channel state information (CSI) configuration type and an identification of a CSI report quantity associated with a first number of channel measurement resources (CMRs). For example, the channel state information (CSI) type and CSI report quantity circuitry 1142, shown and described above in connection with FIG. 11, may provide a means for receiving a channel state information (CSI) configuration type and an identification of a CSI report quantity associated with a first number of channel measurement resources (CMRs).

As described above in connection with FIG. 11, in some examples, the CSI configuration type may be periodic (P), aperiodic (AP), or semipersistent (SP). In some examples, the CSI configuration type and the identification of the CSI report quantity are received from a network and the quantization scheme is reported to the network. In some examples, the CSI report quantity may be at least one of: a reference signal received power (RSRP), a reference signal received quality (RSRQ), or a signal to interference plus noise ratio (SINR). In aspects where the CSI report quantity is an RSRP, the RSPR may be a layer 1-RSRP (L1-RSRP).

At block 1204, the wireless communication device may report a quantization scheme to quantize the CSI report quantity based on a total number of payload bits available to report the CSI report quantity. For example, the quantization scheme circuitry 1143 in combination with the communication and processing circuitry 1141, the transceiver 1114, and antenna array 1116, shown and described above in connection with FIG. 11, may provide a means for reporting a quantization scheme to quantize the CSI report quantity based on a total number of payload bits available to report the CSI report quantity.

As described above in connection with FIG. 11, according to some aspects, the wireless communication device may further receive, in response to the CSI configuration type being periodic, the total number of payload bits via radio resource control (RRC) signaling. In some examples, the wireless communication device may further receive, in response to the CSI configuration type being semipersistent, the total number of payload bits via at least one of: radio resource control (RRC) signaling that configured a CSI report, a medium access control-control element (MAC-CE) that activated the CSI report, or a first downlink control information (DCI) that triggered the CSI report. In other examples, the wireless communication device may further receive, in response to the CSI configuration type being aperiodic, the total number of payload bits via a DCI that triggered the CSI report. For example, the quantization scheme circuitry 1143 in combination with the communication and processing circuitry 1141, the transceiver 1114, and antenna array 1116, shown and described above in connection with FIG. 11, may provide a means for the just described receiving aspects.

In still other examples, the wireless communication device may select the quantization scheme from a standardized predefined list or from a set of quantization scheme options preconfigured at a base station. For example, the quantization scheme circuitry 1143 in combination with the communication and processing circuitry 1141, and the memory 1108 and the quantization schemes 1109 stored on the memory 1108, as shown and described above in connection with FIG. 11, may provide a means for selecting the quantization scheme from a standardized predefined list or from a set of quantization scheme options preconfigured at a base station

According to some aspects, the wireless communication device may at least one of: report for each respective layer 1-RSRP (L1-RSRP) or respective signal to interference plus noise (SINR) of the first number of CMRs, whether a reported value of the respective L1-RSRP or the respective SINR is an absolute value or a differential value, or report for each respective L1-RSRP or respective SINR of the first number of CMRs, a quantity of a number of bits used to quantize the respective L1-RSRP or the respective SINR. According to some aspects, the wireless communication device may further identify the respective L1-RSRP or the respective SINR that serves as a basis for the differential value in a given reporting instance, in response to the reported value being the differential value. Still further, the wireless communication device may report a dynamic range of the quantization scheme and a step-size between adjacent L1-RSRP or SINR codepoints in a given reporting instance, in addition to reporting the quantity of the number of bits used to quantize the respective L1-RSRP or the respective SINR. According to some examples, in response to the CSI configuration type being periodic, the quantization scheme may be configured by an associated CSI report setting and, alternatively, in response to the CSI configuration type being semipersistent or aperiodic, the quantization scheme may be selected from a plurality of quantization schemes that are pre-configured by the associated CSI report setting. In some examples, the wireless communication device may limit a range of the quantization scheme to a subset of the plurality of quantization schemes that are pre-configured by the associated CSI report setting in response to the CSI configuration type being semipersistent or aperiodic and a medium access control-control element (MAC-CE) activating the semipersistent CSI report or a downlink control information (DCI) triggering the aperiodic CSI report. For example, the quantization scheme circuitry 1143 in combination with the communication and processing circuitry 1141, the transceiver 1114, and antenna array 1116, shown and described above in connection with FIG. 11, may provide a means for the just described reporting, identifying, and limiting.

According to some examples, the wireless communication device may report the quantization scheme together with a CSI report in response to the CSI configuration type being periodic, semipersistent, or aperiodic, or the wireless communication device may report the quantization scheme via a medium access control-control element (MAC-CE) in response to the CSI configuration type being periodic or semipersistent. In such examples, the quantization scheme may be reported via the MAC-CE and the quantization scheme may be a default quantization scheme. According to those aspects, the wireless communication device may further report a value in the MAC-CE that indicates that the default quantization scheme is used. In aspects where the quantization scheme is reported via the MAC-CE, the wireless communication device may further identify the alternative quantization scheme in the MAC-CE in response to determining to use an alternative quantization scheme, different from the default quantization scheme. For example, the quantization scheme circuitry 1143 in combination with the communication and processing circuitry 1141, the transceiver 1114, and antenna array 1116, shown and described above in connection with FIG. 11, may provide a means for the just described reporting and identifying.

The wireless communication device may still further receive a confirmation indicating receipt of the MAC-CE and may apply the alternative quantization scheme during a remainder of a reporting instance and onward in time until notified to use a next quantization scheme. According to some aspects, the wireless communication device may report the first number of CMRs. In response to the CSI configuration type being periodic or semipersistent, the wireless communication device may report the first number of CMRs by at least one of: reporting an identifier of an option selected from a plurality of options preconfigured to the wireless communication device by a network access node, reporting the first number of CMRs using a second number of bits based on the first number associated with a CSI report, reporting the first number of CMRs together with the CSI report, or reporting a default value of the first number of CMRs. In response to the CSI configuration type being aperiodic, the wireless communication device may report the first number of CMRs by at least one of: reporting an identifier of the option selected from the plurality of options preconfigured to the wireless communication device by the network access node, reporting the first number of CMRs using the second number of bits based on the first number of CMRs associated with the CSI report, or reporting the first number of CMRs together with the CSI report. For example, the quantization scheme circuitry 1143 in combination with the communication and processing circuitry 1141, the transceiver 1114, and antenna array 1116, shown and described above in connection with FIG. 11, may provide a means for the just described receiving and reporting.

Of course, in the above examples, the circuitry included in the processor 1104 merely provided as an example. Other means for carrying out the described processes or functions may be included within various aspects of the present disclosure, including but not limited to the instructions stored in the computer-readable medium 1110 or any other suitable apparatus or means described in any one of the FIGS. 1, 2, 5, 6, 7, and/or 8 and utilizing, for example, the processes and/or algorithms described herein in relation to FIGS. 4, 9, 10, and/or 12.

The following provides an overview of aspects of the present disclosure:

Aspect 1: A wireless communication device, comprising: a wireless transceiver; a memory, and a processor communicatively coupled to the wireless transceiver and the memory, the processor and the memory being configured to: receive a CSI configuration type and an identification of a CSI report quantity associated with a first number of channel measurement resources (CMRs), and report a quantization scheme to quantize the CSI report quantity based on a total number of payload bits available to report the CSI report quantity.

Aspect 2: The wireless communication device of aspect 1, wherein the CSI configuration type is periodic (P), aperiodic (AP), or semipersistent (SP).

Aspect 3: The wireless communication device of aspect 1 or 2, wherein the CSI configuration type and the identification of the CSI report quantity are received from a network and the quantization scheme is reported to the network.

Aspect 4: The wireless communication device of any of aspects 1 through 3, wherein the processor and the memory are further configured to: receive the total number of payload bits via radio resource control (RRC) signaling in response to the CSI configuration type being periodic,

Aspect 5: The wireless communication device of any of aspects 1 through 4, wherein the processor and the memory are further configured to: receive, in response to the CSI configuration type being semipersistent, the total number of payload bits via at least one of: radio resource control (RRC) signaling that configured a CSI report, a medium access control-control element (MAC-CE) that activated the CSI report, or a first downlink control information (DCI) that triggered the CSI report.

Aspect 6: The wireless communication device of any of aspects 1 through 5, wherein the processor and the memory are further configured to: receive the total number of payload bits via a DCI that triggered the CSI report in response to the CSI configuration type being aperiodic.

Aspect 7: The wireless communication device of any of aspects 1 through 6, wherein the processor and the memory are further configured to: select the quantization scheme from a standardized predefined list or from a set of quantization scheme options preconfigured at a network access node.

Aspect 8: The wireless communication device of any of aspects 1 through 7, wherein the total number of payload bits to report the quantization scheme is determined by total number of a set of quantization scheme options preconfigured at a network access node.

Aspect 9: The wireless communication device of any of aspects 1 through 8, wherein the processor and the memory are further configured to at least one of: report for each respective layer 1-RSRP (L1-RSRP) or respective signal to interference plus noise (SINR) of the first number of CMRs, whether a reported value of the respective L1-RSRP or the respective SINR is an absolute value or a differential value, or report for each respective L1-RSRP or respective SINR of the first number of CMRs, a quantity of a number of bits used to quantize the respective L1-RSRP or the respective SINR.

Aspect 10: The wireless communication device of aspect 9, wherein the processor and the memory are further configured to: identify the respective L1-RSRP or the respective SINR that serves as a basis for the differential value in a given reporting instance, in response to the reported value being the differential value.

Aspect 11: The wireless communication device of any of aspects 1 through 10, wherein the processor and the memory are further configured to: report a dynamic range of the quantization scheme and a step-size between adjacent L1-RSRP or SINR codepoints in a given reporting instance, in addition to reporting the quantity of the number of bits used to quantize the respective L1-RSRP or the respective SINR.

Aspect 12: The wireless communication device of any of aspects 1 through 11, wherein the processor and the memory are further configured to: configure, by an associated CSI report setting, the quantization scheme in response to the CSI configuration type being periodic, and select, from a plurality of quantization schemes that are pre-configured by the associated CSI report setting, the quantization scheme in response to the CSI configuration type being semipersistent or aperiodic.

Aspect 13: The wireless communication device of aspect 12, wherein the processor and the memory are further configured to: limit a range of the quantization scheme to a subset of the plurality of quantization schemes that are pre-configured by the associated CSI report setting in response to the CSI configuration type being semipersistent or aperiodic and a medium access control-control element (MAC-CE) activating the semipersistent CSI report or a downlink control information (DCI) triggering the aperiodic CSI report.

Aspect 14: The wireless communication device of any of aspects 1 through 13, wherein the processor and the memory are further configured to: report the quantization scheme together with a CSI report in response to the CSI configuration type being periodic, semipersistent, or aperiodic, and report the quantization scheme via a medium access control-control element (MAC-CE) in response to the CSI configuration type being periodic or semipersistent.

Aspect 15: The wireless communication device of aspect 14, wherein the quantization scheme is reported via the MAC-CE and the quantization scheme is a default quantization scheme, the processor and the memory are further configured to: report a value in the MAC-CE that indicates that the default quantization scheme is used.

Aspect 16: The wireless communication device of aspect 14, wherein the quantization scheme is reported via the MAC-CE, and wherein the processor and the memory are further configured to: identify the alternative quantization scheme in the MAC-CE in response to determining to use an alternative quantization scheme, different from the default quantization scheme.

Aspect 17: The wireless communication device of aspect 16, wherein the processor and the memory are further configured to: receive a confirmation indicating receipt of the MAC-CE and apply the alternative quantization scheme during a remainder of a reporting instance and onward in time until notified to use a next quantization scheme.

Aspect 18: The wireless communication device of any of aspects 1 through 17, wherein the processor and the memory are further configured to: report the first number of CMRs.

Aspect 19: The wireless communication device of any of aspects 1 through 18, wherein the processor and the memory are further configured to: report the first number of CMRs, in response to the CSI configuration type being periodic or semipersistent, by at least one of: reporting an identifier of an option selected from a plurality of options preconfigured to the wireless communication device by a network access node, reporting the first number of CMRs using a second number of bits based on the first number of CMRs associated with a CSI report, reporting the first number of CMRs together with the CSI report, or reporting a default value of the first number of CMRs.

Aspect 20: The wireless communication device of aspect 18, wherein the processor and the memory are further configured to: report, in response to the CSI configuration type being aperiodic, the first number of CMRs by at least one of: reporting an identifier of the option selected from the plurality of options preconfigured to the wireless communication device by a network access node, reporting the first number of CMRs using the second number of bits based on the first number of CMRs associated with the CSI report, or reporting the first number of CMRs together with the CSI report.

Aspect 21: A method at a wireless communication device, the method comprising: receiving a CSI configuration type and an identification of a CSI report quantity associated with a first number of channel measurement resources (CMRs) and reporting a quantization scheme to quantize the CSI report quantity based on a total number of payload bits available to report the CSI report quantity.

Aspect 22: The method of aspect 21, wherein the CSI configuration type is periodic (P), aperiodic (AP), or semipersistent (SP).

Aspect 23: The method of aspect 21 or 22, wherein the CSI configuration type and the identification of the CSI report quantity are received from a network and the quantization scheme is reported to the network.

Aspect 24: The method of any of aspects 21 through 23, wherein the CSI report quantity is at least one of: a reference signal received power (RSRP), a reference signal received quality (RSRQ), or a signal to interference plus noise ratio (SINR).

Aspect 25: The method of aspect 24, wherein the RSRP is a layer 1-RSRP (L1-RSRP).

Aspect 26: The method of any of aspects 21 through 25, further comprising: receiving, in response to the CSI configuration type being periodic, the total number of payload bits via radio resource control (RRC) signaling.

Aspect 27: The method of any of aspects 21 through 26, further comprising: receiving, in response to the CSI configuration type being semipersistent, the total number of payload bits via at least one of: radio resource control (RRC) signaling that configured a CSI report, a medium access control-control element (MAC-CE) that activated the CSI report, or a first downlink control information (DCI) that triggered the CSI report.

Aspect 28: The method of any of aspects 21 through 27, further comprising: receiving, in response to the CSI configuration type being aperiodic, the total number of payload bits via a DCI that triggered the CSI report.

Aspect 29: The method of any of aspects 21 through 28, further comprising: selecting the quantization scheme from a standardized predefined list or from a set of quantization scheme options preconfigured at a network access node.

Aspect 30: The method of any of aspects 21 through 29, wherein the total number of payload bits to report the quantization scheme is determined by total number of a set of quantization scheme options preconfigured at the base station.

Aspect 31: The method of any of aspects 21 through 30, further comprising at least one of: reporting for each respective layer 1-RSRP (L1-RSRP) or respective signal to interference plus noise (SINR) of the first number of CMRs, whether a reported value of the respective L1-RSRP or the respective SINR is an absolute value or a differential value, or reporting for each respective L1-RSRP or respective SINR of the first number of CMRs, a quantity of a number of bits used to quantize the respective L1-RSRP or the respective SINR.

Aspect 32: The method of aspect 31, further comprising: identifying the respective L1-RSRP or the respective SINR that serves as a basis for the differential value in a given reporting instance, in response to the reported value being the differential value.

Aspect 33: The method of aspect 31, further comprising: reporting a dynamic range of the quantization scheme and a step-size between adjacent L1-RSRP or SINR codepoints in a given reporting instance, in addition to reporting the quantity of the number of bits used to quantize the respective L1-RSRP or the respective SINR.

Aspect 34: The method of any of aspects 21 through 33, further comprising: configuring, by an associated CSI report setting, the quantization scheme in response to the CSI configuration type being periodic, and selecting, from a plurality of quantization schemes that are pre-configured by the associated CSI report setting, the quantization scheme in response to the CSI configuration type being semipersistent or aperiodic.

Aspect 35: The method of aspect 34, further comprising: limiting a range of the quantization scheme to a subset of the plurality of quantization schemes that are pre-configured by the associated CSI report setting in response to the CSI configuration type being semipersistent or aperiodic and a medium access control-control element (MAC-CE) activating the semipersistent CSI report or a downlink control information (DCI) triggering the aperiodic CSI report.

Aspect 36: The method of any of aspects 21 through 35, further comprising: reporting the quantization scheme together with a CSI report in response to the CSI configuration type being periodic, semipersistent, or aperiodic; or reporting the quantization scheme via a medium access control-control element (MAC-CE) in response to the CSI configuration type being periodic or semipersistent.

Aspect 37: The method of aspect 36, wherein the quantization scheme is reported via the MAC-CE and the quantization scheme is a default quantization scheme, the method further comprising: reporting a value in the MAC-CE that indicates that the default quantization scheme is used.

Aspect 38: The method of aspect 36, wherein the quantization scheme is reported via the MAC-CE, the method further comprising: identifying the alternative quantization scheme in the MAC-CE in response to determining to use an alternative quantization scheme, different from the default quantization scheme.

Aspect 39: The method of aspect 38, further comprising: receiving a confirmation indicating receipt of the MAC-CE and applying the alternative quantization scheme during a remainder of a reporting instance and onward in time until notified to use a next quantization scheme.

Aspect 40: The method of any of aspects 21 through 39, further comprising: reporting the first number of CMRs.

Aspect 41: The method of aspect 40, wherein: in response to the CSI configuration type being periodic or semipersistent, the wireless communication device reports the first number of CMRs by at least one of: reporting an identifier of an option selected from a plurality of options preconfigured to the wireless communication device by a network access node, reporting the first number of CMRs using a second number of bits based on the first number CMRs associated with a CSI report, reporting the first number of CMRs together with the CSI report, or reporting a default value of the first number of CMRs.

Aspect 42: The method of aspect 40, wherein: in response to the CSI configuration type being aperiodic, the wireless communication device reports the first number of CMRs by at least one of: reporting an identifier of the option selected from the plurality of options preconfigured to the wireless communication device by the network access node, reporting the first number of CMRs using the second number of bits based on the first number of CMRs associated with the CSI report, or reporting the first number of CMRs together with the CSI report.

Aspect 43: An apparatus configured for wireless communication comprising at least one means for performing a method of any one of aspects 21 through 42.

Aspect 31: A non-transitory computer-readable medium storing computer-executable code, comprising code for causing an apparatus to perform a method of any one of aspects 21 through 42.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover: A; B; and A and B. The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

1. A wireless communication device, comprising:
a wireless transceiver;
a memory; and
a processor communicatively coupled to the wireless transceiver and the memory, the processor and the memory being configured to:
receive a CSI configuration type and an identification of a CSI report quantity associated with a first number of channel measurement resources (CMRs); and
report a quantization scheme to quantize the CSI report quantity based on a total number of payload bits available to report the CSI report quantity.

2. The wireless communication device of claim 1, wherein the CSI configuration type is periodic (P), aperiodic (AP), or semipersistent (SP).

3. The wireless communication device of claim 1, wherein the CSI configuration type and the identification of the CSI report quantity are received from a network and the quantization scheme is reported to the network.

4. The wireless communication device of claim 1, wherein the processor and the memory are further configured to:
receive the total number of payload bits via radio resource control (RRC) signaling in response to the CSI configuration type being periodic.

5. The wireless communication device of claim 1, wherein the processor and the memory are further configured to:
receive, in response to the CSI configuration type being semipersistent, the total number of payload bits via at least one of:
radio resource control (RRC) signaling that configured a CSI report,
a medium access control-control element (MAC-CE) that activated the CSI report, or
a first downlink control information (DCI) that triggered the CSI report.

6. The wireless communication device of claim 1, wherein the processor and the memory are further configured to:
receive the total number of payload bits via a DCI that triggered the CSI report in response to the CSI configuration type being aperiodic.

7. The wireless communication device of claim 1, wherein the processor and the memory are further configured to:
select the quantization scheme from a standardized predefined list or from a set of quantization scheme options preconfigured at a network access node.

8. The wireless communication device of claim 1, wherein the total number of payload bits to report the quantization scheme is determined by total number of a set of quantization scheme options preconfigured at a network access node.

9. The wireless communication device of claim 1, wherein the processor and the memory are further configured to at least one of:
report for each respective layer 1-RSRP (L1-RSRP) or respective signal to interference plus noise ratio (SINR) of the first number of CMRs, whether a reported value of the respective L1-RSRP or the respective SINR is an absolute value or a differential value, or
report for each respective L1-RSRP or respective SINR of the first number of CMRs, a quantity of a number of bits used to quantize the respective L1-RSRP or the respective SINR.

10. The wireless communication device of claim 9, wherein the processor and the memory are further configured to:
identify the respective L1-RSRP or the respective SINR that serves as a basis for the differential value in a given reporting instance, in response to the reported value being the differential value.

11. The wireless communication device of claim 9, wherein the processor and the memory are further configured to:
report a dynamic range of the quantization scheme and a step-size between adjacent L1-RSRP or SINR codepoints in a given reporting instance, in addition to reporting the quantity of the number of bits used to quantize the respective L1-RSRP or the respective SINR.

12. The wireless communication device of claim 1, wherein the processor and the memory are further configured to:
configure, by an associated CSI report setting, the quantization scheme in response to the CSI configuration type being periodic; and
select, from a plurality of quantization schemes that are pre-configured by the associated CSI report setting, the quantization scheme in response to the CSI configuration type being semipersistent or aperiodic.

13. The wireless communication device of claim 12, wherein the processor and the memory are further configured to:
limit a range of the quantization scheme to a subset of the plurality of quantization schemes that are pre-configured by the associated CSI report setting in response to the CSI configuration type being semipersistent or aperiodic and a medium access control-control element (MAC-CE) activating a semipersistent CSI report or a downlink control information (DCI) triggering an aperiodic CSI report.

14. The wireless communication device of claim 1, wherein the processor and the memory are further configured to:
report the quantization scheme together with a CSI report in response to the CSI configuration type being periodic, semipersistent, or aperiodic; and
report the quantization scheme via a medium access control-control element (MAC-CE) in response to the CSI configuration type being periodic or semipersistent.

15. The wireless communication device of claim 14, wherein the quantization scheme is reported via the MAC-CE and the quantization scheme is a default quantization scheme, the processor and the memory are further configured to:
report a value in the MAC-CE that indicates that the default quantization scheme is used.

16. The wireless communication device of claim 15, wherein the quantization scheme is reported via the MAC-CE, and wherein the processor and the memory are further configured to:
identify an alternative quantization scheme in the MAC-CE in response to determining to use the alternative quantization scheme, different from the default quantization scheme.

17. The wireless communication device of claim 16, wherein the processor and the memory are further configured to:
receive a confirmation indicating receipt of the MAC-CE; and
apply the alternative quantization scheme during a remainder of a reporting instance and onward in time until notified to use a next quantization scheme.

18. The wireless communication device of claim 1, wherein the processor and the memory are further configured to:
report the first number of CMRs.

19. The wireless communication device of claim 18, wherein the processor and the memory are further configured to:
report the first number of CMRs, in response to the CSI configuration type being periodic or semipersistent, by at least one of:
reporting an identifier of an option selected from a plurality of options preconfigured to the wireless communication device by a network access node,
reporting the first number of CMRs using a second number of bits based on the first number of CMRs associated with a CSI report,
reporting the first number of CMRs together with the CSI report, or
reporting a default value of the first number of CMRs.

20. The wireless communication device of claim 18, wherein the processor and the memory are further configured to:
report, in response to the CSI configuration type being aperiodic, the first number of CMRs by at least one of:
reporting an identifier of an option selected from a plurality of options preconfigured to the wireless communication device by a network access node,
reporting the first number of CMRs using a second number of bits based on the first number of CMRs associated with the CSI report, or
reporting the first number of CMRs together with the CSI report.

21. A method at a wireless communication device, the method comprising:
receiving a CSI configuration type and an identification of a CSI report quantity associated with a first number of channel measurement resources (CMRs); and
reporting a quantization scheme to quantize the CSI report quantity based on a total number of payload bits available to report the CSI report quantity.

22. The method of claim 21, wherein the CSI configuration type is periodic (P), aperiodic (AP), or semipersistent (SP).

23. The method of claim 21, wherein the CSI configuration type and the identification of the CSI report quantity are received from a network and the quantization scheme is reported to the network.

24. The method of claim 21, further comprising:
receiving, in response to the CSI configuration type being periodic, the total number of payload bits via radio resource control (RRC) signaling.

25. The method of claim 21, further comprising:
receiving, in response to the CSI configuration type being semipersistent, the total number of payload bits via at least one of:
radio resource control (RRC) signaling that configured a CSI report,
a medium access control-control element (MAC-CE) that activated the CSI report, or
a first downlink control information (DCI) that triggered the CSI report.

26. The method of claim 21, further comprising:
receiving, in response to the CSI configuration type being aperiodic, the total number of payload bits via a DCI that triggered the CSI report.

27. The method of claim 21, further comprising:
selecting the quantization scheme from a standardized predefined list or from a set of quantization scheme options preconfigured at a network access node.

28. The method of claim 21, further comprising at least one of:
reporting for each respective layer 1-RSRP (L1-RSRP) or respective signal to interference plus noise ratio (SINR) of the first number of CMRs, whether a reported value of the respective L1-RSRP or the respective SINR is an absolute value or a differential value, or
reporting for each respective L1-RSRP or respective SINR of the first number of CMRs, a quantity of a number of bits used to quantize the respective L1-RSRP or the respective SINR.

29. The method of claim 21, further comprising:
configuring, by an associated CSI report setting, the quantization scheme in response to the CSI configuration type being periodic; and
selecting, from a plurality of quantization schemes that are pre-configured by the associated CSI report setting, the quantization scheme in response to the CSI configuration type being semipersistent or aperiodic.

30. The method of claim 21, further comprising:
reporting the quantization scheme together with a CSI report in response to the CSI configuration type being periodic, semipersistent, or aperiodic; or
reporting the quantization scheme via a medium access control-control element (MAC-CE) in response to the CSI configuration type being periodic or semipersistent.
